(19) United States
(12) Patent Application Publication
(10) Pub. No.: US 2025/0008556 A1
(43) Pub. Date: Jan. 2, 2025

(54) WIRELESS COMMUNICATION SYSTEM, WIRELESS TERMINAL CONTROL METHOD, CONTROL DEVICE, AND CONTROL PROGRAM

(71) Applicant: NIPPON TELEGRAPH AND TELEPHONE CORPORATION, Tokyo (JP)

(72) Inventors: Junichi IWATANI, Tokyo (JP); Shoko SHINOHARA, Tokyo (JP); Yusuke ASAI, Tokyo (JP); Yasushi TAKATORI, Tokyo (JP); Tomoyuki YAMADA, Tokyo (JP); Yoshitaka SHIMIZU, Tokyo (JP)

(73) Assignee: NIPPON TELEGRAPH AND TELEPHONE CORPORATION, Tokyo (JP)

(21) Appl. No.: 18/707,603

(22) PCT Filed: Nov. 30, 2021
(86) PCT No.: PCT/JP2021/043842

§ 371 Date: May 6, 2024

(51) Int. Cl. H04W 74/04; H04W 72/02

(52) U.S. Cl. CPC H04W 74/04; H04W 72/02

(57) ABSTRACT

The wireless communication system includes a wireless terminal and a control unit. The wireless terminal includes a plurality of wireless modules that respectively perform wireless communication with a plurality of base stations on different channels. The wireless terminal uses one of the plurality of wireless modules as a use module, and stops data transmission from wireless modules other than the use module. The control unit performs switching of the use module in the wireless terminal such that a transmission time rate of each of the plurality of wireless modules does not exceed a predetermined upper limit.

### TECHNICAL FIELD

The present disclosure relates to a technique for controlling a wireless terminal that performs wireless communication by switching a plurality of channels.

### BACKGROUND ART

There is a wireless communication system including a base station and a wireless terminal. A typical example of the wireless communication system is a wireless local area network (LAN) for public use. In the wireless LAN for public use, for example, a use case in which data is transmitted from a base station to a wireless terminal such as a computer terminal or a smartphone terminal is assumed. With the spread of Internet of Things (IoT) terminals in recent years, use cases in which data is transmitted from a wireless terminal side to a base station are increasing.

In connection with wireless communication for the IoT, use of an unlicensed Sub-1 GHz band has been systematized in many countries around the world (refer to Non Patent Literature 1 and Non Patent Literature 2). In Japan, a 920 MHz band is allocated as a frequency band of an electronic tag system. For example, as an active electronic tag system, there is a low power wide area (LPWA) wireless communication system such as LoRa (registered trademark) or WiSUN (registered trademark). Use of IEEE 802.11ah, which is one wireless LAN standard, has also been studied.

Since the number of frequency channels is limited in the 920 MHz band, there may be a case where wireless communication is performed while switching the channel that is used.

For example, in Japan, a total transmission time at the time of using the 920 MHz band is limited, and a total transmission time per hour needs to be within 360 seconds. Throughput is also limited because a wireless communication apparatus limits data transmission to comply with this total transmission time limit. However, for a housing of a wireless communication apparatus that switches and uses two non-overlapping channels, a total transmission time of 360 seconds for each channel per hour and up to 720 seconds in total is allowed. Therefore, in order to improve the throughput, it is conceivable to perform wireless communication while switching the channels used by the housing of the wireless communication apparatus.

### CITATION LIST

### Non Patent Literature

Non Patent Literature 1: “920 MHZ-BAND TELEMETER, TELECONTROL AND DATA TRANSMISSION RADIO EQUIPMENT ARIB STANDARDS”, Association of Radio Industries and Businesses, ARIB STD-T108, Version 1.3, Apr. 12, 2019 Non Patent Literature 2: “IEEE Standard for Information technology-Telecommunications and information exchange between systems Local and metropolitan area networks—Specific requirements, Part 11: Wireless LAN Medium Access Control (MAC) and Physical Layer (PHY) Specifications, Amendment 2: Sub 1 GHz License Exempt Operation”, IEEE Computer Society, IEEE Std 802.11ah TM-2016, 7 Dec. 2016.

### SUMMARY OF INVENTION

### Technical Problem

A case where a wireless terminal transmits data to a base station is assumed. In a situation where there is a restriction on a transmission time rate for each channel, it is conceivable to improve the throughput by switching channels used by the wireless terminal. However, complicated processing is required to switch channels used in a wireless module included in the wireless terminal.

One object of the present invention is to provide a technique capable of simplifying a process of switching channels used by a wireless terminal.

### Solution to Problem

A first aspect relates to a wireless communication system.

The wireless communication system includes a wireless terminal and a control unit.

The wireless terminal includes a plurality of wireless modules that respectively perform wireless communication with a plurality of base stations on different channels.

The wireless terminal uses one of the plurality of wireless modules as a use module, and stops data transmission from wireless modules other than the use module.

The control unit performs switching of the use module in the wireless terminal such that a transmission time rate of each of the plurality of wireless modules does not exceed a predetermined upper limit.

A second aspect relates to a wireless terminal control method for controlling a wireless terminal.

The wireless terminal includes a plurality of wireless modules that respectively perform wireless communication with a plurality of base stations on different channels.

The wireless terminal control method includes:
a process of selecting one of the plurality of wireless modules as a use module;
a process of stopping data transmission from a wireless module other than the use module; and
a process of performing switching of the use module in the wireless terminal such that a transmission time rate of each of the plurality of wireless modules does not exceed a predetermined upper limit.

A third aspect relates to a control device that controls a wireless terminal.

The wireless terminal includes a plurality of wireless modules that respectively perform wireless communication with a plurality of base stations on different channels.

The control device includes one or a plurality of processors.

The one or more processors are configured to execute
a process of selecting one of the plurality of wireless modules as a use module,
a process of stopping data transmission from a wireless module other than the use module, and
a process of performing switching of the use module in the wireless terminal such that a transmission time rate of each of the plurality of wireless modules does not exceed a predetermined upper limit.

A fourth aspect relates to a control program executed by a computer. The control program causes a computer to execute the wireless terminal control method according to the second aspect. Alternatively, the control program causes a computer to implement the control device according to the third aspect.

### Advantageous Effects of Invention

According to the present invention, the wireless terminal includes the plurality of wireless modules that respectively perform wireless communication with the plurality of base stations on different channels. The control unit switches use modules used by the wireless terminal among the plurality of wireless modules. By switching use modules among the plurality of wireless modules, it is possible to easily switch channels used for wireless communication. Since it is not necessary to switch channels in a single wireless module, it is possible to simplify processing required for channel switching.

### BRIEF DESCRIPTION OF DRAWINGS

FIG. 1 is a block diagram illustrating a configuration example of a wireless communication system according to an embodiment.

FIG. 2 is a timing chart for describing an outline of a module switching process according to the embodiment.

FIG. 3 is a block diagram illustrating a configuration example of the wireless communication system according to the first embodiment.

FIG. 4 is a timing chart for describing an example of a module switching process according to a first embodiment.

FIG. 5 is a flowchart schematically illustrating processing related to the module switching process according to the first embodiment.

FIG. 6 is a block diagram illustrating a configuration example of a wireless communication system according to a second embodiment.

FIG. 7 is a timing chart for describing an example of a module switching process according to the second embodiment.

FIG. 8 is a block diagram illustrating a configuration example of a wireless communication system according to a third embodiment.

FIG. 9 is a timing chart for describing an example of a module switching process according to the third embodiment.

FIG. 10 is a block diagram illustrating a configuration example of a wireless communication system according to a fourth embodiment.

FIG. 11 is a block diagram illustrating another configuration example of the wireless communication system according to the fourth embodiment.

FIG. 12 is a timing chart for describing an example of a module switching process according to the fourth embodiment.

FIG. 13 is a block diagram illustrating a configuration example of a wireless communication system according to a fifth embodiment.

FIG. 14 is a timing chart for describing an example of a timing setting process according to the fifth embodiment.

FIG. 15 is a flowchart illustrating processing performed by a control unit according to the fifth embodiment.

FIG. 16 is a block diagram illustrating a configuration example of a wireless communication system according to a sixth embodiment.

FIG. 17 is a timing chart for describing an example of a connection process according to the sixth embodiment.

FIG. 18 is a flowchart illustrating processing performed by a control unit according to the sixth embodiment.

### DESCRIPTION OF EMBODIMENTS

Embodiments of the present invention will be described with reference to the accompanying drawings.

### 1. Outline

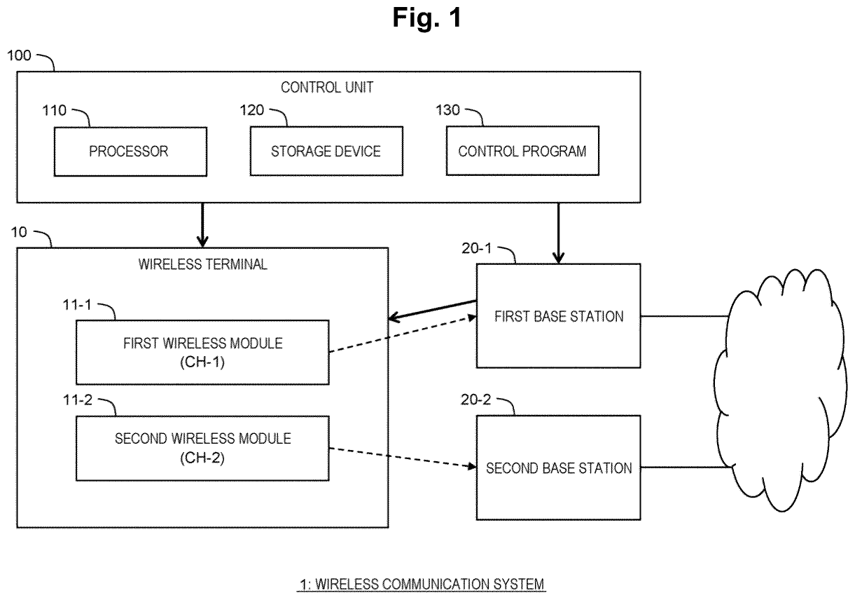

FIG. 1 is a block diagram illustrating a configuration example of a wireless communication system 1 according to the present embodiment. The wireless communication system 1 includes a wireless terminal 10 and a plurality of base stations 20. The wireless terminal 10 and each base station 20 configure a wireless communication network and perform wireless communication with each other. For example, the wireless communication system 1 is a wireless LAN system, and the base station 20 is an access point of the wireless LAN. The wireless communication system 1 performs wireless communication by using, for example, the unlicensed Sub-1 GHz band. For example, the wireless communication system 1 performs wireless communication by using the 920 MHz band.

The wireless terminal 10 can perform wireless communication by switching a plurality of channels (frequency channels). More specifically, the wireless terminal 10 includes a plurality of wireless modules 11 that perform wireless communication on different channels that do not overlap each other. Each wireless module 11 includes, for example, a network interface control unit (network interface card). The plurality of wireless modules 11 are respectively connected to a plurality of base stations 20 and perform wireless communication with the plurality of base stations 20.

In the example illustrated in FIG. 1, the wireless terminal 10 includes a first wireless module 11-1 and a second wireless module 11-2. The first wireless module 11-1 is set to perform wireless communication on a first channel CH-1. The first wireless module 11-1 is connected to the first base station 20-1 and performs wireless communication with the first base station 20-1 on the first channel CH-1. On the other hand, the second wireless module 11-2 is set to perform wireless communication on a second channel CH-2 that does not overlap with the first channel CH-1. The second wireless module 11-2 is connected to the second base station 20-2 and performs wireless communication with the second base station 20-2 on the second channel CH-2.

By switching the wireless modules 11 used when the wireless terminal 10 performs wireless communication with the base station 20, it is possible to easily switch the channels used for wireless communication. One of the plurality of wireless modules 11 that is selectively used will be hereinafter referred to as a “use module 11S”. The use module 11S may also be referred to as a “selection module”. A process of switching the use modules 11S in the wireless terminal 10 will be hereinafter referred to as a “module switching process”.

Next, a situation in which there is a restriction (upper limit) on the transmission time rate for each channel used by the wireless terminal 10 will be considered. For example, in Japan, a total transmission time at the time of using the 920 MHz band is limited, and a total transmission time per hour needs to be within 360 seconds. A total transmission time of 360 seconds for each channel per hour and up to 720 seconds in total is allowed for a housing that switches and uses two non-overlapping channels. Therefore, in order to improve the throughput, the module switching process of switching the use modules 11S in the wireless terminal 10 is effective.

The wireless communication system 1 according to the present embodiment further includes a “control unit 100” that manages and controls the module switching process. The control unit 100 selects one of the plurality of wireless modules 11 included in the wireless terminal 10 as the use module 11S. The control unit 100 monitors and manages a transmission time and a transmission time rate of each channel of the plurality of wireless modules 11. The control unit 100 performs the module switching process of switching the use modules 11S such that the transmission time rate of each channel of the plurality of wireless modules 11 does not exceed a predetermined upper limit.

For example, the control unit 100 is included in the wireless terminal 10. As another example, the control unit 100 may be connected to the wireless terminal 10 and control the wireless terminal 10 from the outside. As still another example, the control unit 100 may be included in the base station 20 and control the wireless terminal 10 via communication. As still another example, the control unit 100 may be connected to the base station 20 and control the wireless terminal 10 via the base station 20. The control unit 100 may also be referred to as a “control device”.

The control unit 100 may be a computer including one or more processors 110 (hereinafter, simply referred to as a “processor 110”) and one or more storage devices 120 (hereinafter, simply referred to as a “storage device 120”). For example, the processor 110 includes a central processing unit (CPU). The storage device 120 stores various types of information necessary for processing of the processor 110. Examples of the storage device 120 include a volatile memory, a non-volatile memory, a hard disk drive (HDD), and a solid state drive (SSD).

The control program 130 is a computer program executed by the processor 110. The processor 110 executes the control program 130 to realize the function of the control unit 100. The control program 130 is stored in the storage device 120. The control program 130 may be recorded on a computer-readable recording medium. The control program 130 may be provided to the control unit 100 via a network.

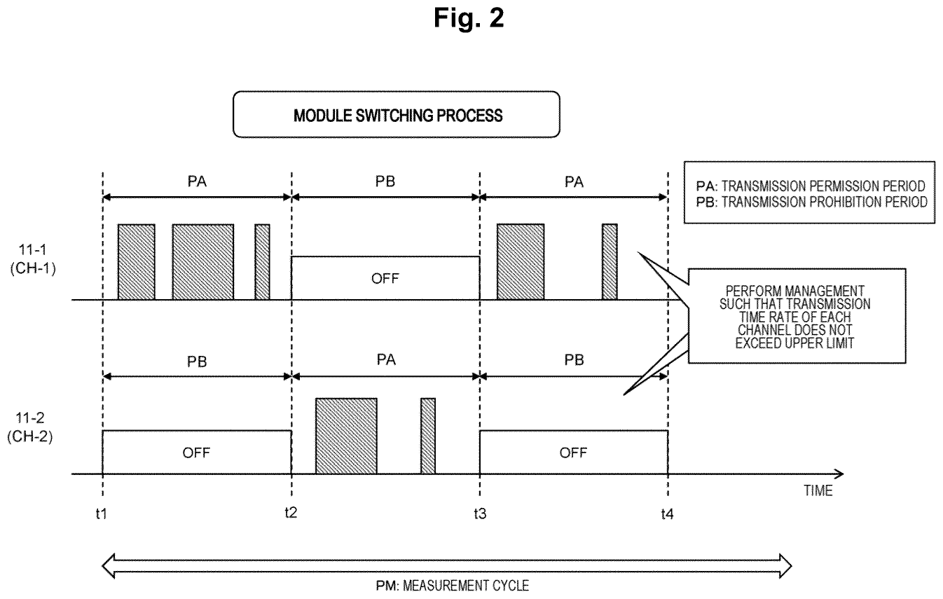

FIG. 2 is a timing chart for describing an outline of a module switching process according to the present embodiment. Here, switching between the first wireless module 11-1 (first channel CH-1) and the second wireless module 11-2 (second channel CH-2) is considered.

During a period from time point t1 to time point t2, the control unit 100 selects the first wireless module 11-1 as the use module 11S. Control unit 100 permits data transmission from the first wireless module 11-1, but prohibits data transmission from the second wireless module 11-2. That is, the period from time point t1 to time point t2 is a transmission permission period PA for the first wireless module 11-1 and a transmission prohibition period PB for the second wireless module 11-2. The wireless terminal 10 performs wireless communication with the first base station 20-1 on the first channel CH-1 by using the first wireless module 11-1 as the use module 11S. On the other hand, the wireless terminal 10 stops the data transmission from the second wireless module 11-2. The control unit 100 constantly monitors a transmission time and a transmission time rate of the first wireless module 11-1.

At time point t2, the control unit 100 performs a module switching process to switch the use module 11S from the first wireless module 11-1 to the second wireless module 11-2.

During a period from time point t2 to time point t3, the control unit 100 selects the second wireless module 11-2 as the use module 11S. The control unit 100 permits data transmission from the second wireless module 11-2, but prohibits data transmission from the first wireless module 11-1. That is, the period from time point t2 to time point t3 is the transmission prohibition period PB for the first wireless module 11-1, and is the transmission permission period PA for the second wireless module 11-2. The wireless terminal 10 performs wireless communication with the second base station 20-2 on the second channel CH-2 by using the second wireless module 11-2 as the use module 11S. On the other hand, the wireless terminal 10 stops the data transmission from the first wireless module 11-1. The control unit 100 constantly monitors a transmission time and a transmission time rate of the second wireless module 11-2.

At time point t3, the control unit 100 performs a module switching process to switch the use module 11S from the second wireless module 11-2 to the first wireless module 11-1. The period from time point t3 to time point t4 is similar to the period from time point t1 to time point t2.

As a trigger for the control unit 100 to execute the module switching process, various examples may be considered as will be described later. For example, the control unit 100 may perform the module switching process at regular time intervals. As another example, the control unit 100 may perform the module switching process in a case where the communication quality of the use module 11S deteriorates. In any case, the control unit 100 according to the present exemplary embodiment performs the module switching process such that the transmission time rate of each wireless module 11 (each channel) does not exceed a predetermined upper limit. For this purpose, the control unit 100 monitors and manages a transmission time of each of the plurality of wireless modules 11 in a measurement cycle PM. The control unit 100 performs the module switching process such that a transmission time of each wireless module 11 in the measurement cycle PM is equal to or less than a certain value.

In a case where a transmission time rate of a certain wireless module 11 exceeds the predetermined upper limit, the control unit 100 stops using the wireless module 11. In a case where the transmission time rate of the entire wireless terminal 10 exceeds the predetermined upper limit, the control unit 100 stops the data transmission from the wireless terminal 10.

### <Effects>

As described above, according to the present embodiment, the wireless terminal 10 includes the plurality of wireless modules 11 that respectively perform wireless communication with the plurality of base stations 20 on different channels. The control unit 100 performs a module switching process of switching the use modules 11S used by the wireless terminal 10 among the plurality of wireless modules 11. In particular, the control unit 100 performs the module switching process such that the transmission time rate of each of the plurality of wireless modules 11 does not exceed the predetermined upper limit.

By switching the use modules 11S among the plurality of wireless modules 11, channels used for wireless communication can be easily switched. Since it is not necessary to switch channels in a single wireless module 11, it is possible to simplify processing required for channel switching. Since the restart of the wireless terminal 10 is unnecessary for the channel switching, the communication interruption time is reduced, and the degradation of the service quality is prevented.

Since the control unit 100 accurately manages the transmission time rate of each of the plurality of wireless modules 11, each channel can be used up to the upper limit of the transmission time rate. That is, it is possible to increase the transmission time rate of the entire wireless terminal 10 and effectively improve the throughput.

Since the wireless terminal 10 includes the plurality of wireless modules 11, redundancy is secured and reliability is improved.

Hereinafter, various embodiments will be described in more detail.

### 2. Various Embodiments

### 2-1. First Embodiment

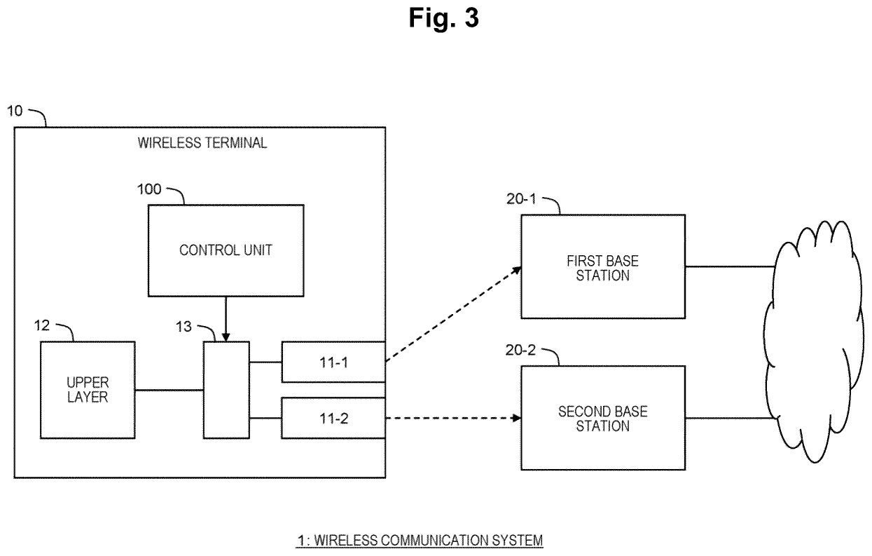

FIG. 3 is a block diagram illustrating a configuration example of a wireless communication system 1 according to a first embodiment. In a first example, the control unit 100 is included in the wireless terminal 10. That is, the wireless terminal 10 includes the control unit 100. The wireless terminal 10 further includes a plurality of wireless modules 11, an upper layer 12, and a selector 13.

The control unit 100 selects one of the plurality of wireless modules 11 as the use module 11S. The control unit 100 notifies the selector 13 of the selected use module 11S. The selector 13 receives transmission data from the upper layer 12 and outputs the transmission data to the use module 11S. The selector 13 does not transmit the transmission data to the wireless modules 11 other than the use module 11S. The use module 11S transmits the transmission data from the upper layer 12, and the wireless modules 11 other than the use module 11S stop the data transmission.

The control unit 100 monitors and manages a transmission time and a transmission time rate of each of the plurality of wireless modules 11. The control unit 100 performs a module switching process of switching the use modules 11S. Any trigger for the module switching process is used, but the control unit 100 performs the module switching process such that at least the transmission time rate of each of the plurality of wireless modules 11 does not exceed a predetermined upper limit.

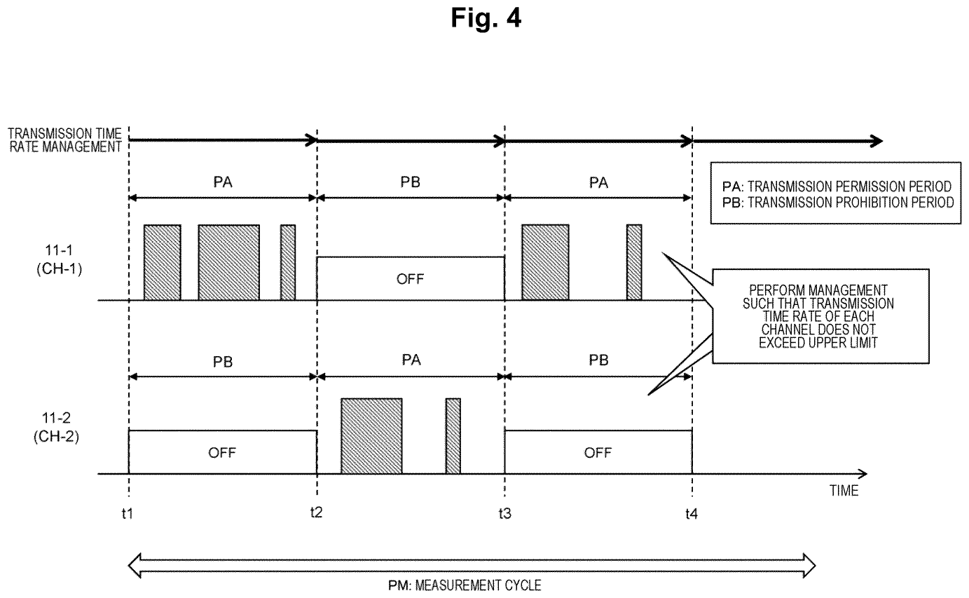

FIG. 4 is a timing chart for describing an example of a module switching process according to the first embodiment. The same description as that of FIG. 2 described above will not be repeated herein. The control unit 100 manages (monitors) a transmission time rate of each of the first wireless module 11-1 and the second wireless module 11-2. For example, the control unit 100 manages (monitors) a transmission time of each of the first wireless module 11-1 and the second wireless module 11-2 in the measurement cycle PM. The control unit 100 performs the module switching process such that a transmission time of each wireless module 11 in the measurement cycle PM is equal to or less than a certain value. For example, in a case where the transmission time rate of the use module 11S reaches a predetermined upper limit, the control unit 100 performs a module switching process.

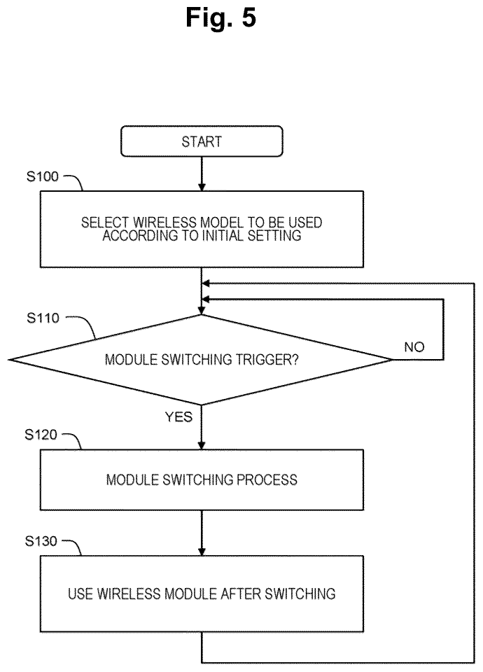

FIG. 5 is a flowchart schematically illustrating processing related to the module switching process.

In step S100, the control unit 100 selects one of the plurality of wireless modules 11 as the use module 11S according to an initial setting. The wireless terminal 10 performs wireless communication with the base station 20 by using the use module 11S.

In step S110, the control unit 100 determines the presence or absence of a trigger for the module switching process. In other words, the control unit 100 determines whether or not conditions for executing the module switching process (hereinafter, referred to as “module switching conditions”) are established. For example, the module switching conditions are that a transmission time rate of the use module 11S reaches a predetermined upper limit. Other examples of the module switching conditions will be described later. In a case where the module switching conditions are not established (step S110; No), the process returns to step S110. On the other hand, in a case where the module switching conditions are established (step S110; Yes), the process proceeds to step S120.

In step S120, the control unit 100 performs the module switching process to switch the use modules 11S.

In step S130, the wireless terminal 10 performs wireless communication with the base station 20 by using the use module 11S after the switching. The process returns to step S110.

### 2-2. Second Embodiment

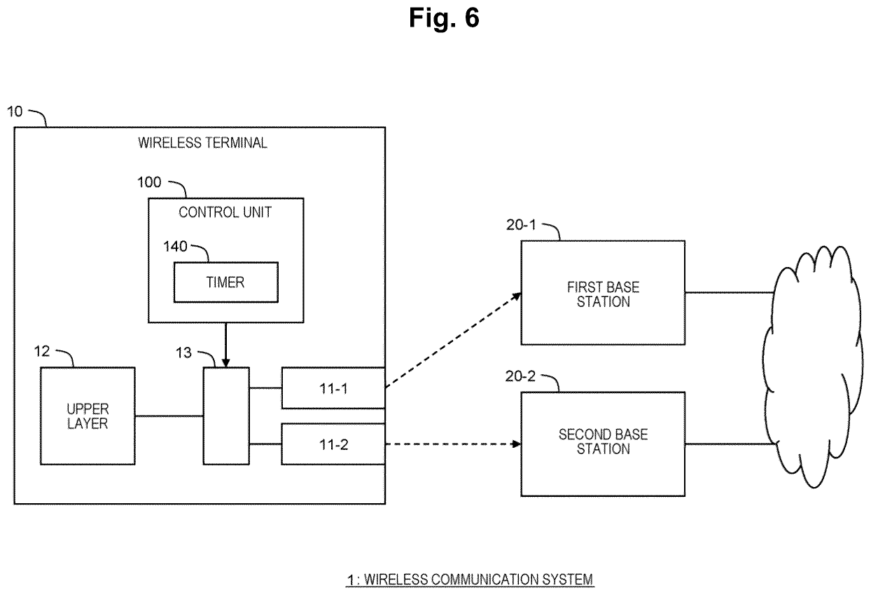

FIG. 6 is a block diagram illustrating a configuration example of a wireless communication system 1 according to a second embodiment. The same description as that of the first embodiment will not be repeated herein. The control unit 100 is included in the wireless terminal 10. The control unit 100 performs a module switching process such that at least a transmission time rate of each of the plurality of wireless modules 11 does not exceed a predetermined upper limit.

In the second embodiment, the control unit 100 includes a timer 140 that measures a certain time. The control unit 100 may perform the module switching process at regular time intervals with reference to the timer 140. That is, the module switching conditions in step S110 may include that “a certain time elapses from the start of use of the use module 11S”. Thus, a transmission time of each wireless module 11 is secured.

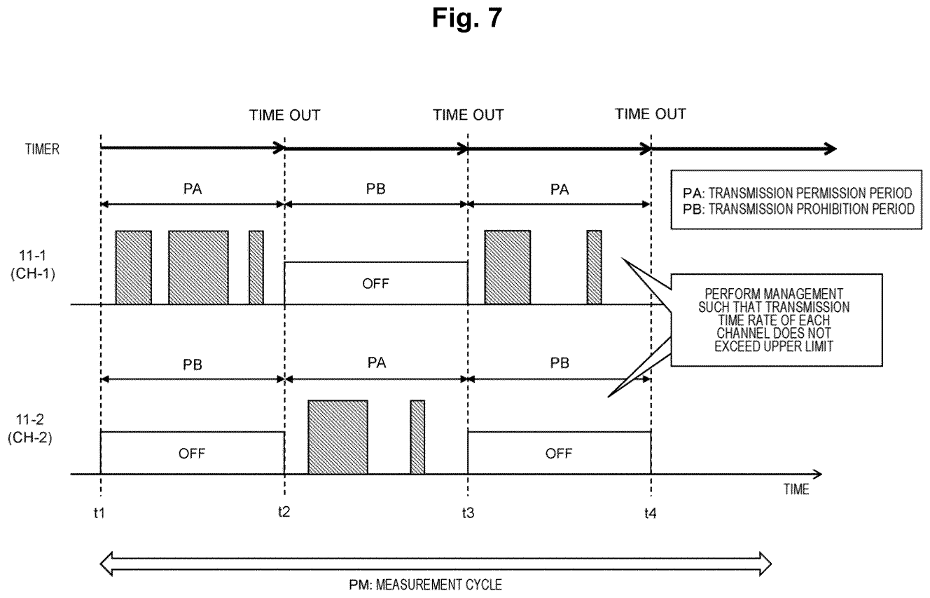

FIG. 7 is a timing chart for describing an example of a module switching process according to the second embodiment. The same description as that of FIG. 2 described above will not be repeated herein. The control unit 100 performs a module switching process at regular time intervals, that is, every time a timeout occurs. The control unit 100 also manages a transmission time rate of each wireless module 11, and performs a module switching process such that the transmission time rate does not exceed a predetermined upper limit.

### 2-3. Third Embodiment

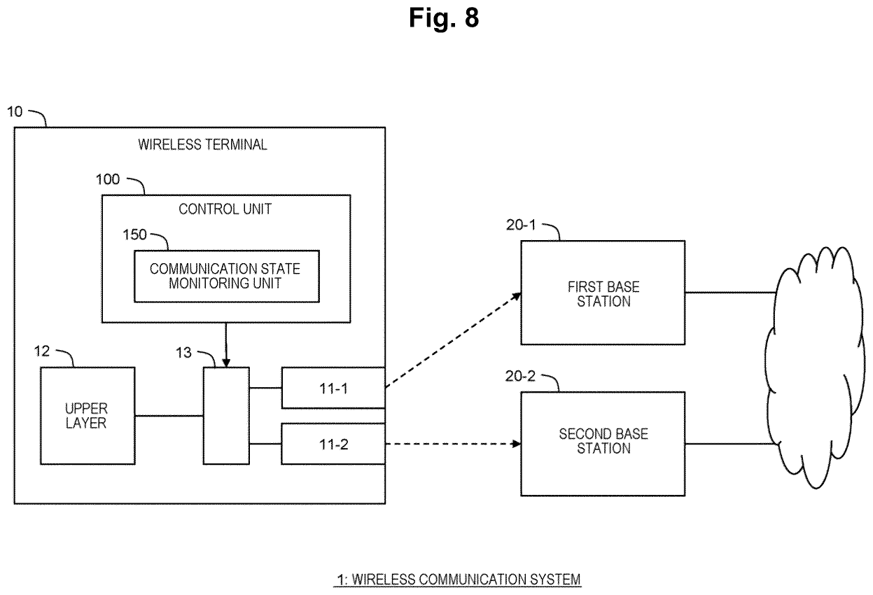

FIG. 8 is a block diagram illustrating a configuration example of a wireless communication system 1 according to a third embodiment. The same description as that of the first embodiment will not be repeated herein. The control unit 100 is included in the wireless terminal 10. The control unit 100 performs a module switching process such that at least a transmission time rate of each of the plurality of wireless modules 11 does not exceed a predetermined upper limit.

In the third embodiment, the control unit 100 includes a communication state monitoring unit 150. The communication state monitoring unit 150 monitors a communication state of each of the plurality of wireless modules 11. In particular, the communication state monitoring unit 150 monitors a communication quality of the use module 11S. Examples of the communication quality include throughput, a communication delay, a received radio wave strength, and a carrier sense standby time. In a case where the communication quality of the use module 11s decreases to a threshold value or less, the control unit 100 may perform the module switching process. That is, the module switching conditions in step S110 described above may include that “a communication quality of the use module 11S decreases to a threshold value or less”. Consequently, it is possible to avoid deterioration in communication quality.

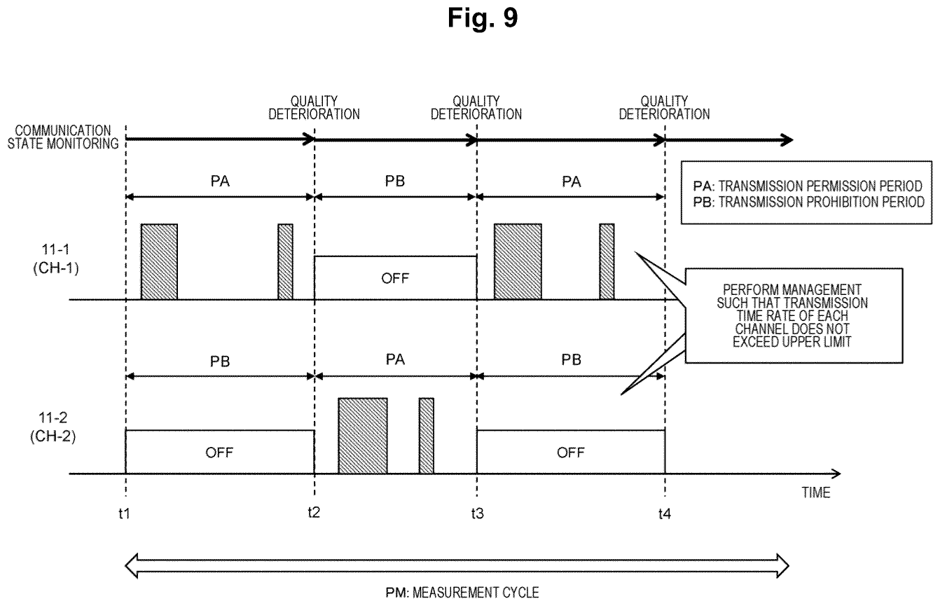

FIG. 9 is a timing chart for describing an example of a module switching process according to a third embodiment. The same description as that of FIG. 2 described above will not be repeated herein. The control unit 100 monitors a communication state, and performs the module switching process in a case where the communication quality of the use module 11S decreases to the threshold value or less. The control unit 100 also manages a transmission time rate of each wireless module 11, and performs a module switching process such that the transmission time rate does not exceed a predetermined upper limit.

### 2-4. Fourth Embodiment

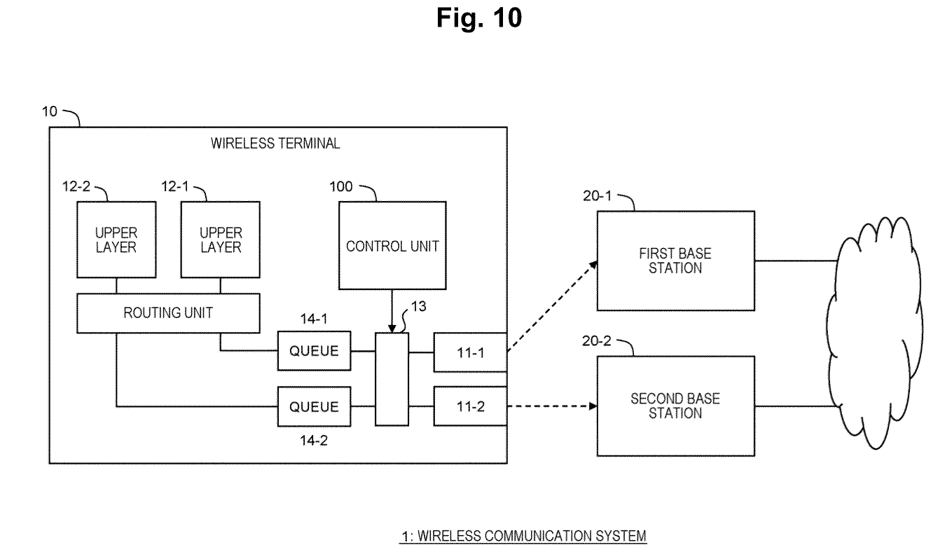

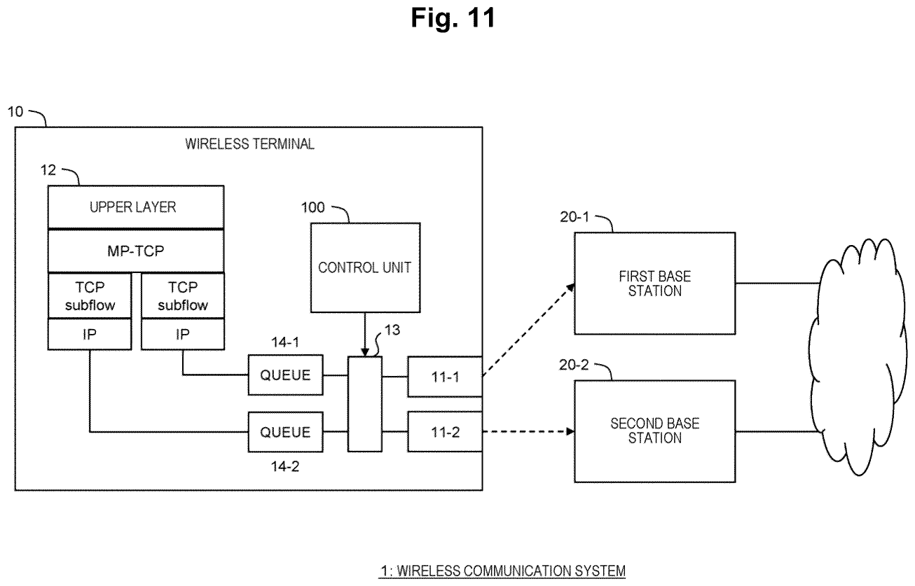

FIGS. 10 and 11 are block diagrams illustrating a configuration example of a wireless communication system 1 according to a fourth embodiment. The same description as that of the first embodiment will not be repeated herein. The control unit 100 is included in the wireless terminal 10. The control unit 100 performs a module switching process such that at least a transmission time rate of each of the plurality of wireless modules 11 does not exceed a predetermined upper limit.

In the fourth embodiment, there are a plurality of upper layers 12 of data transmission sources. The plurality of wireless modules 11 and the plurality of upper layers 12 are associated with each other. That is, the plurality of wireless modules 11 are respectively allocated to the plurality of upper layers 12. The plurality of wireless modules 11 are used for data transmission from the plurality of respective upper layers 12. For example, in FIG. 10, the first wireless module 11-1 is used for data transmission from the first upper layer 12-1 (for example, IoT). The second wireless module 11-2 is used for data transmission from the second upper layer 12-2 (for example, file transfer). As a result, a channel can be selectively used according to the quality required in the upper layer 12.

As illustrated in FIG. 10, the wireless terminal 10 may include a routing unit that distributes transmission data from the plurality of upper layers 12 to the plurality of wireless modules 11. As another example, as illustrated in FIG. 11, it is also possible to transmit data of a plurality of TCP connections by using different wireless modules 11 according to Multipath-TCP (MPTCP).

The wireless terminal 10 includes a plurality of queues 14 for the plurality of respective wireless modules 11. For example, the first queue 14-1 is provided for the first wireless module 11-1, and the second queue 14-2 is provided for the second wireless module 11-2. The wireless module 11 other than the use module 11S may stop to be used and thus transmission standby may occur in the corresponding queue 14.

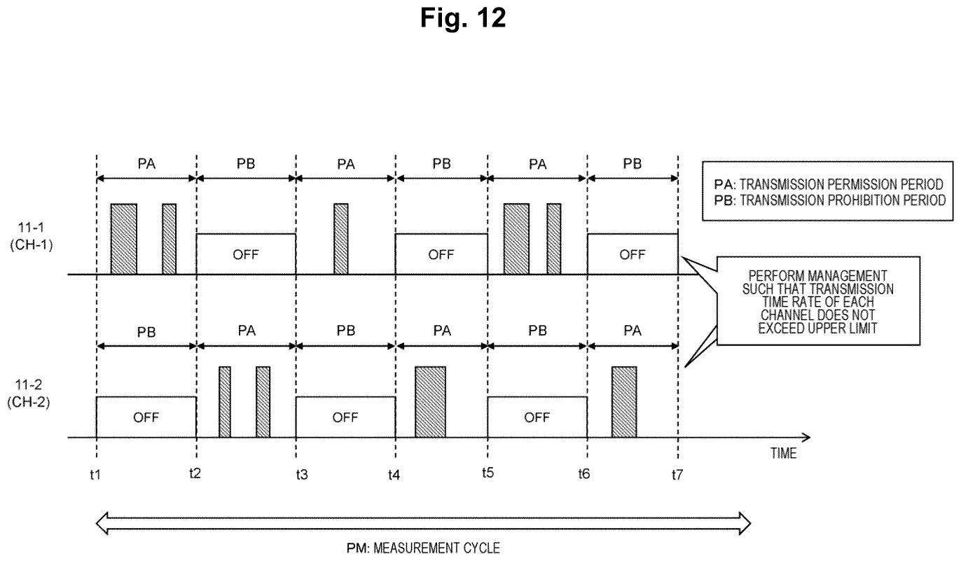

FIG. 12 is a timing chart for describing a method for suppressing a delay caused by transmission standby in the queue 14. The same description as that of FIG. 2 described above will not be repeated herein. As illustrated in FIG. 12, a frequency of the channel switching process is set to be higher than that in the other embodiments. A cycle of the channel switching process may be set by a timer. By setting the frequency of the channel switching process to be high, transmission standby in each queue 14 is suppressed. A timing of data transfer from the queue 14 may be adjusted such that data is not discarded in the wireless module 11.

### 2-5. Fifth Embodiment

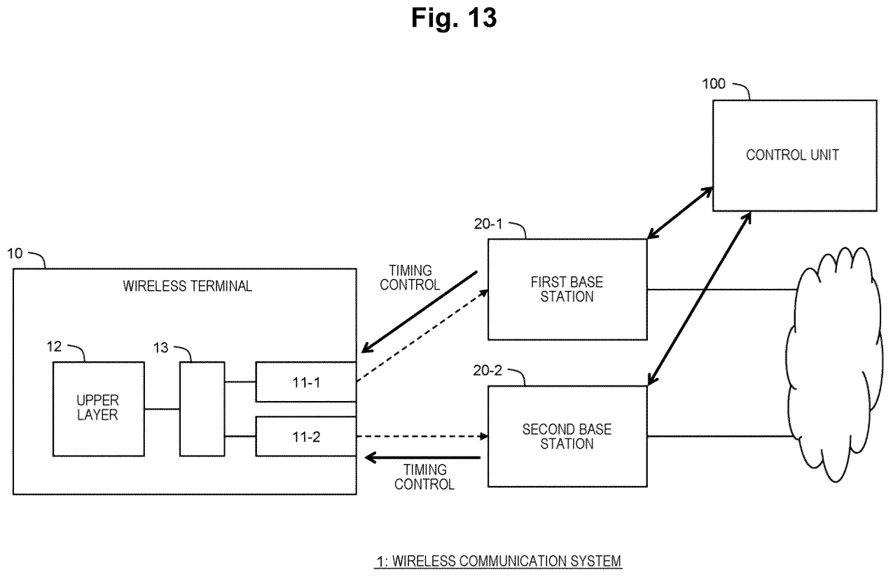

FIG. 13 is a block diagram illustrating a configuration example of a wireless communication system 1 according to a fifth embodiment. The same description as that of the first embodiment will not be repeated herein. In the fifth embodiment, the control unit 100 is connected to a plurality of base stations 20. The control unit 100 manages and controls the wireless terminal 10 via the base station 20. In particular, the control unit 100 manages and sets (designates) a transmission permission timing of each wireless module 11 of the wireless terminal 10.

More specifically, the control unit 100 allocates transmission permission timings (transmission permission periods PA) that do not overlap each other to the plurality of wireless modules 11 of the wireless terminal 10. In other words, transmission prohibition timings (transmission prohibition periods PB) that do not overlap each other are allocated to the plurality of wireless modules 11 of the wireless terminal 10. In this case, the control unit 100 allocates the transmission permission timing such that a transmission time rate of each wireless module 11 does not exceed a predetermined upper limit. The control unit 100 sets transmission permission timings that do not overlap each other in the plurality of wireless modules 11 via the plurality of respective base stations 20. Each wireless module 11 of the wireless terminal 10 operates as the use module 11S at the set transmission permission timing, and stops data transmission at timings other than the transmission permission timing.

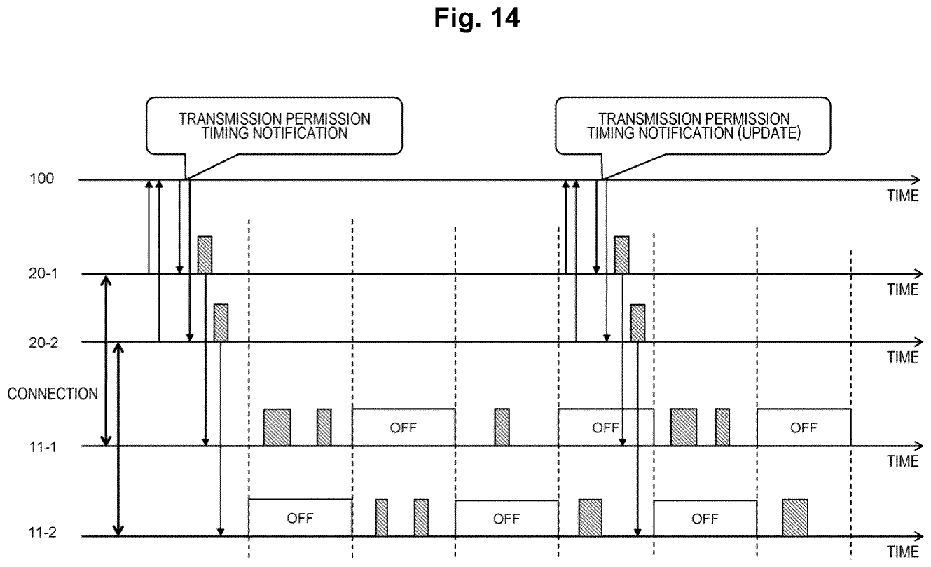

FIG. 14 is a timing chart for describing an example of a timing setting process according to the fifth embodiment. A connection process is performed between the first wireless module 11-1 and the first base station 20-1. A connection process is performed between the second wireless module 11-2 and the second base station 20-2.

The control unit 100 allocates transmission permission timings (transmission permission periods PA) that do not overlap each other to the first wireless module 11-1 and the second wireless module 11-2. The control unit 100 notifies the first base station 20-1 of the transmission permission timing of the first wireless module 11-1. The first base station 20-1 sets the transmission permission timing in the first wireless module 11-1. Such a setting may be performed, for example, by using a target wake time (TWT). Similarly, the control unit 100 notifies the second base station 20-2 of the transmission permission timing of the second wireless module 11-2. The second base station 20-2 sets the transmission permission timing in the second wireless module 11-2. Each of the first wireless module 11-1 and the second wireless module 11-2 operates as the use module 11S at the set transmission permission timing, and stops data transmission at timings other than the transmission permission timing.

During the communication, the control unit 100 may update the transmission permission timing of each wireless module 11. For example, the control unit 100 ascertains a communication quality and a traffic status of each of the plurality of base stations 20. The traffic status may include a transmission time rate of each wireless module 11 and a transmission time rate of the base station 20. The control unit 100 updates the transmission permission timing of each wireless module 11 on the basis of the communication quality and the traffic status of each base station 20. For example, the control unit 100 updates the transmission permission timing such that a transmission time rate of each wireless module 11 does not exceed a predetermined upper limit.

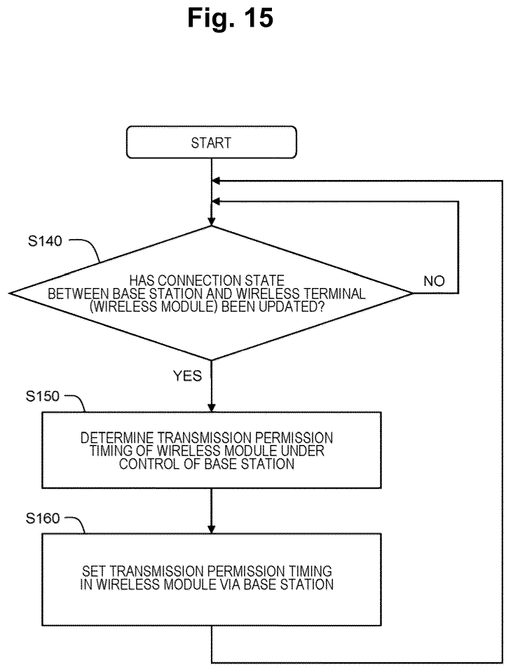

FIG. 15 is a flowchart illustrating processing performed by the control unit 100 according to the fifth embodiment.

In step S140, the control unit 100 determines whether or not a connection state update notification has been received from any of the base stations 20. The connection state update notification is a notification indicating that the connection state between the base station 20 and the wireless terminal 10 (wireless module 11) has been updated. In a case where the connection state update notification has been received (step S140; Yes), the process proceeds to step S150.

In step S150, the control unit 100 determines a transmission permission timing of each wireless module 11 under the control of the base station 20. In this case, a transmission permission timing of each wireless module 11 is determined such that transmission permission timings do not overlap among the plurality of wireless modules 11. In step S160, the control unit 100 sets the transmission permission timing in each wireless module 11 via the base station 20.

### 2-6. Sixth Embodiment

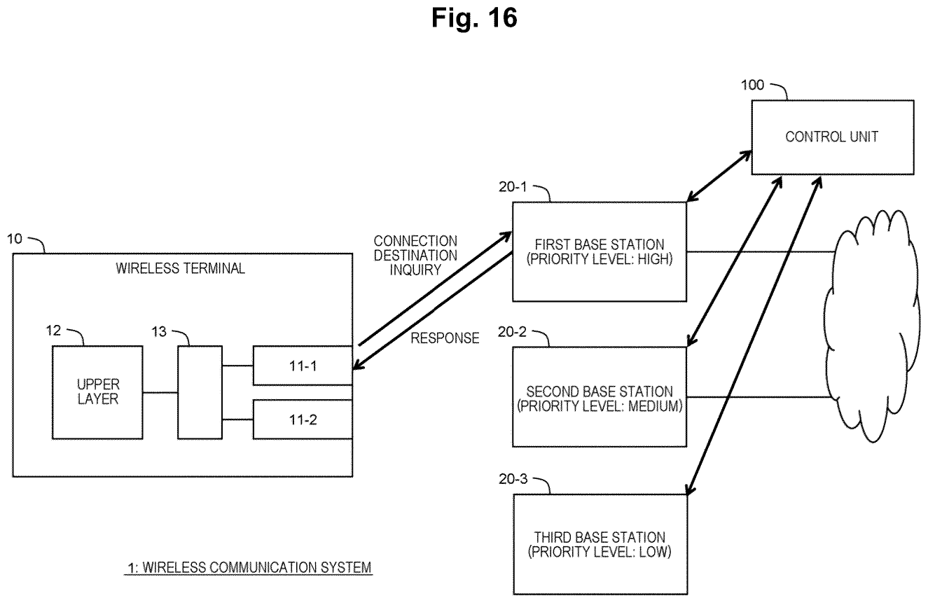

FIG. 16 is a block diagram illustrating a configuration example of a wireless communication system 1 according to a sixth embodiment. The same description as that of the first embodiment will not be repeated herein. In the sixth embodiment, the control unit 100 is connected to a plurality of base stations 20. The control unit 100 manages and controls the wireless terminal 10 via the base station 20.

In the sixth embodiment, in particular, a connection process between the wireless module 11 and the base station 20 is considered. In a case where the wireless module 11 is connected to the base station 20, it is assumed that a plurality of base stations 20 are present as connection destination candidates. In this case, the control unit 100 designates an optimum one from the plurality of base stations 20 (connection destination possibilities).

More specifically, the control unit 100 constantly monitors states of the plurality of base stations 20. The control unit 100 sets a priority level of each base station 20 on the basis of a state (examples: a congestion status, downlink traffic, and a transmission time rate of a base station) of each base station 20. For example, the control unit 100 ascertains a congestion status of the base station 20 on the basis of available bandwidths, the number of terminals being connected, and the like. The control unit 100 lowers the priority level of the base station 20 having a small wireless resource margin. As another example, in a case where there is a restriction on the transmission time rate also with respect to downlink traffic from the base station 20 to the wireless terminal 10, the control unit 100 ascertains the current statuses of the downlink traffic and the transmission time rate. The control unit 100 lowers the priority level of the base station 20 having a small margin of the transmission time rate.

The control unit 100 selects one base station 20 that is a connection destination of the wireless module 11 according to the priority level of each base station 20. For example, in FIG. 16, the control unit 100 is connected to the first base station 20-1, the second base station 20-2, and the third base station 20-3. In a case where the priority level of the first base station 20-1 is the highest among the base stations, the control unit 100 selects the first base station 20-1 as a connection destination. As a result, a connection destination of the wireless module 11 can be appropriately selected according to a status on the base station 20 side.

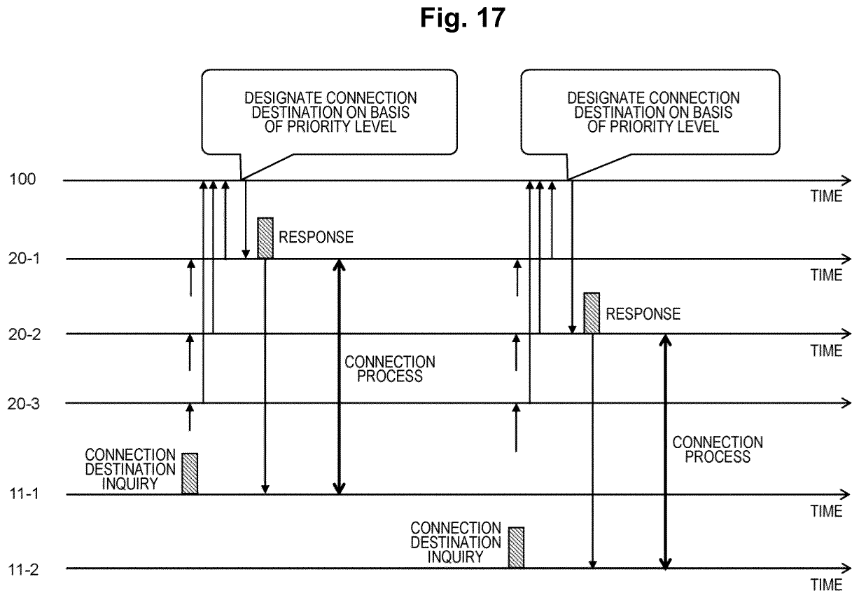

FIG. 17 is a timing chart for describing an example of a connection process according to the sixth embodiment. For example, the first wireless module 11-1 of the wireless terminal 10 inquires of the surrounding base station 20 about a connection destination. Each base station 20 notifies the control unit 100 of reception of the connection destination inquiry. The control unit 100 selects a connection destination of the first wireless module 11-1 from among the plurality of base stations 20 according to the priority levels of the plurality of base stations 20. Here, for example, the first base station 20-1 has the highest priority level, and thus the first base station 20-1 is selected. The control unit 100 instructs the selected first base station 20-1 to return a respond to the first wireless module 11-1. In response to the instruction from the control unit 100, the first base station 20-1 returns a response to the first wireless module 11-1 that is a connection destination inquiry source. As a result, a connection process is performed between the first wireless module 11-1 and the first base station 20-1.

Thereafter, the second wireless module 11-2 of the wireless terminal 10 inquires of the surrounding base station 20 about a connection destination. Each base station 20 notifies the control unit 100 of reception of the connection destination inquiry. The control unit 100 selects a connection destination of the second wireless module 11-2 from among the plurality of base stations 20 according to the priority levels of the plurality of base stations 20. Here, for example, the second base station 20-2 has the highest priority, and thus the second base station 20-2 is selected. The control unit 100 instructs the selected the second base station 20-2 to return a respond to the second wireless module 11-2. In response to the instruction from the control unit 100, the second base station 20-2 returns a response to the second wireless module 11-2 that is a connection destination inquiry source. As a result, a connection process is performed between the second wireless module 11-2 and the second base station 20-2.

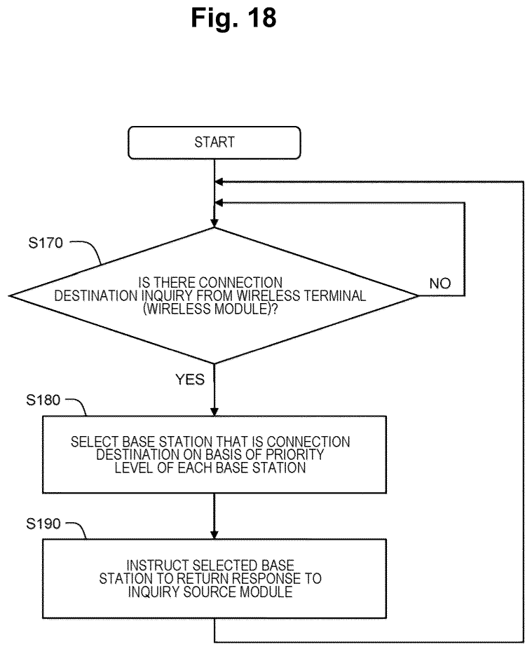

FIG. 18 is a flowchart illustrating processing performed by the control unit 100 according to the sixth embodiment.

In step S170, the control unit 100 determines whether or not a connection destination inquiry reception notification has been received from at least one base station 20. The connection destination inquiry reception notification is a notification indicating that the base station 20 has received a connection destination inquiry from the wireless terminal 10 (wireless module 11). In a case where the connection destination inquiry reception notification has been received (step S170; Yes), the process proceeds to step S180.

In step S180, the control unit 100 selects one base station 20 that is a connection destination of the wireless module 11 on the basis of a priority level of each base station 20.

In step S190, the control unit 100 instructs the selected base station 20 to return a respond to the wireless module 11 that is a connection destination inquiry source.

### 3. Summary

As described above, according to the present embodiment, the wireless terminal 10 includes the plurality of wireless modules 11 that respectively perform wireless communication with the plurality of base stations 20 on different channels. The control unit 100 performs a module switching process of switching the use modules 11S used by the wireless terminal 10 among the plurality of wireless modules 11. In particular, the control unit 100 performs the module switching process such that the transmission time rate of each of the plurality of wireless modules 11 does not exceed the predetermined upper limit.

By switching the use modules 11S among the plurality of wireless modules 11, channels used for wireless communication can be easily switched. Since it is not necessary to switch channels in a single wireless module 11, it is possible to simplify processing required for channel switching. Since the restart of the wireless terminal 10 is unnecessary for the channel switching, the communication interruption time is reduced, and the degradation of the service quality is prevented.

Since the control unit 100 accurately manages the transmission time rate of each of the plurality of wireless modules 11, each channel can be used up to the upper limit of the transmission time rate. That is, it is possible to increase the transmission time rate of the entire wireless terminal 10 and effectively improve the throughput.

Since the wireless terminal 10 includes the plurality of wireless modules 11, redundancy is secured and reliability is improved.

### REFERENCE SIGNS LIST

1 Wireless communication system
10 Wireless terminal
11 Wireless module 11
11-1 First wireless module
11-2 Second wireless module
11S Use module
12 Upper layer
13 Selector
20 Base station
20-1 First base station
20-2 Second base station
100 Control unit
110 Processor
120 Storage device
130 Control program
140 Timer
150 Communication state monitoring unit
PA Transmission permission period
PB Transmission prohibition period

1. A wireless communication system comprising:
a wireless terminal including a plurality of wireless modules that respectively perform wireless communication with a plurality of base stations on different channels; and
control circuitry,
wherein:
the wireless terminal uses one of the plurality of wireless modules as a use module and stops data transmission from wireless modules other than the use module, and
the control circuitry performs switching of the use module in the wireless terminal such that a transmission time rate of each of the plurality of wireless modules does not exceed a predetermined upper limit.

2. The wireless communication system according to claim 1, wherein:
the control circuitry monitors a transmission time of each of the plurality of wireless modules in a measurement cycle, and performs switching of the use module in the wireless terminal such that the transmission time of each of the plurality of wireless modules in the measurement cycle is equal to or less than a certain value.

3. The wireless communication system according to claim 1, wherein:
the control circuitry determines whether or not module switching conditions are established, and performs switching of the use module in a case where the module switching conditions are established, and
the module switching conditions include that a certain time elapses from start of use of the use module or that a communication quality of the use module decreases to a threshold value or less.

4. The wireless communication system according to claim 1, wherein:
the plurality of wireless modules are respectively allocated to a plurality of upper layers that are data transmission sources, and are used for data transmission from each of the plurality of upper layers.

5. The wireless communication system according to claim 1, wherein:
the control circuitry is connected to the plurality of base stations,
the control circuitry sets transmission permission timings that do not overlap each other in the plurality of wireless modules of the wireless terminal via each of the plurality of base stations, and
each of the plurality of wireless modules operates as the use module at a transmission permission timing and stops data transmission at timings other than the transmission permission timing.

6. A wireless terminal control method for controlling a wireless terminal including a plurality of wireless modules that respectively perform wireless communication with a plurality of base stations on different channels, the method comprising:
selecting one of the plurality of wireless modules as a use module;
stopping data transmission from a wireless module other than the use module; and
performing switching of the use module in the wireless terminal such that a transmission time rate of each of the plurality of wireless modules does not exceed a predetermined upper limit.

7. A control device that controls a wireless terminal including a plurality of wireless modules that respectively perform wireless communication with a plurality of base stations on different channels, the control device comprising:
one or more processors,
wherein the one or more processors are configured to execute:
a process of selecting one of the plurality of wireless modules as a use module,
a process of stopping data transmission from a wireless module other than the use module, and
a process of performing switching of the use module in the wireless terminal such that a transmission time rate of each of the plurality of wireless modules does not exceed a predetermined upper limit.

8. A non-transitory computer readable medium storing a control program that is executed by a computer and causes the computer to realize the control device according to claim 7.

9. A non-transitory computer readable medium storing a program that causes a computer to execute the method of claim 6.
